(19) United States
(12) Patent Application Publication
(10) Pub. No.: US 2013/0234859 A1
(43) Pub. Date: Sep. 12, 2013

(54) Method for Transmission of Data from a Downhole Sensor Array

(71) Applicant: CATHEDRAL ENERGY SERVICES LTD., Nisku (CA)

(72) Inventors: Bogdan A. PICIOREANU, Calgary (CA); Randal H. PUSTANYK, Chestermere (CA)

(73) Assignee: CATHEDRAL ENERGY SERVICES LTD., Nisku (CA)

(21) Appl. No.: 13/765,725

(22) Filed: Feb. 13, 2013

(30) Foreign Application Priority Data
Mar. 8, 2012 (CA) 2770979

(51) Int. Cl. G01V 3/18

(52) U.S. Cl. CPC G01V 3/18
USPC 340/853.1

(57) ABSTRACT

A method for transmission of data from a downhole sensor array. A continuous unidirectional data stream is sent from the downhole sensor array to two or more different types of data transmitters at the same time. One or more of the two or more different types of data transmitters is then activated to transmit the data from the downhole sensor array. If desired, all of the different types of data transmitters may be activated to contemporaneously transmit the data from the downhole sensor array

### FIELD

There is described a method of transmitting data collected by a downhole sensor array to surface that was developed for use when directional drilling with measurement while drilling systems.

### BACKGROUND

Traditional Measurement While Drilling (MWD) systems utilize a combination of processors and data sensors such as inclination, direction, temperature, gamma ray, resistivity etc. referred to as a sensor array to determine the trajectory and lithology of wellbores being drilled within the earth. The data is generally transmitted to surface via single transmission mode, either mud pulse, Electro-magnetic (EM), Electric Dipole, Acoustic etc. The MWD tool generally encompasses three main elements, a sensor array comprising a series of data sensors and processor for sensing the required data from the wellbore, A power source (typically batteries or generator), and a transmitter and processor assembly for encoding and sending data to surface where it is decoded to useful information. Within the downhole tool string are a series of electronics to record and process the sensor data into a format suitable for transmission via the applicable transmitter type. Many of the tools employ a processor in the transmitter assembly that polls (requests) data from the sensor array and then receives the requested data which is processed, stored in memory and transmitted. The processor typically requests information from each sensor individually. In many applications all of the sensors may be on a net-bus (network) connected to the processor. In some applications individual sensors may accumulate data for others, and then transfer a package of combined data to the main processor. When a transmitter processor requests information then awaits a reply, it is often referred to as a “command mode”, “send-receive mode” or “bi-directional mode” of operation. This method is suitable for MWD systems that utilize a single transmitter assembly and sensor array as there is uninterrupted communication line between the pair.

Canadian patents 2,544,457 (Petrovic et al) entitled “System and Method for Downhole Telemetry” and 2,584,671 (Petrovic et al) entitled “System and Method for Downhole Telemetry” describe measurement while drilling (MWD), logging while drilling (LWD) and seismic while drilling (SWD) applications in which transmission of data to from drilling tools downhole to surface is necessary. The Petrovic et al '457 patent and the

Petrovic et al '671 patent also describe various sources of data and methods of data transmission such as electromagnetic telemetry (EM) and mud pulse telemetry. EM telemetry is described as being preferred for most applications due to a faster transmission rate. However, should the EM signal be lost due either failure or adverse geological conditions, considerable time is lost in switching to a backup system, such as mud pulse telemetry as this generally requires tripping the downhole tool string out of the well bore. Besides being comparatively slow, mud pulse telemetry is described as also having an inherent disadvantage in that it is only capable of operating when drilling fluids are being circulated. The Petrovic et al '457 patent and the Petrovic et al '671 patent then describe a proposed solution in which the system is capable of operating in either a EM telemetry mode or a mud pulse telemetry mode. There will hereinafter be described an alternative solution which provides advantages over the method taught in the Petrovic et al patents.

### SUMMARY

There is provided a method for transmission of data from a downhole sensor array. A continuous unidirectional data stream is sent from the downhole sensor array to two or more different types of data transmitters at the same time. One or more of the two or more different types of data transmitters is then activated to transmit the data from the downhole sensor array.

In accordance with the teachings of this method, there are two or more data transmitters receiving the data and any type of data transmitter that is most appropriate given current conditions can be activated with the other data transmitters being deactivated.

Another unique aspect of this method is that more than one of the two or more different types of data transmitters can be activated and contemporaneously transmit the data from the downhole sensor array. With sensor data being contemporaneously transmitted from two or more different types of data transmitters, there is almost always access to data from at least one of the data transmitters. If adverse geological conditions interrupt the EM telemetry or electric dipole telemetry signal, mud pulse telemetry or acoustic telemetry remain available. If circulation of drilling fluids has temporarily stopped, interrupting the mud pulse telemetry signal; EM telemetry, electric dipole telemetry or acoustic telemetry remains available.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view, in section, of a measurement while drilling (MWD) tool positioned downhole in a wellbore.

FIG. 2 is a schematic diagram showing contemporaneous transmission by more than one transmitter of data received from a sensor array.

FIG. 3 is a schematic diagram showing a variation with contemporaneous transmission by more than one transmitter of data received from a sensor array.

### DETAILED DESCRIPTION

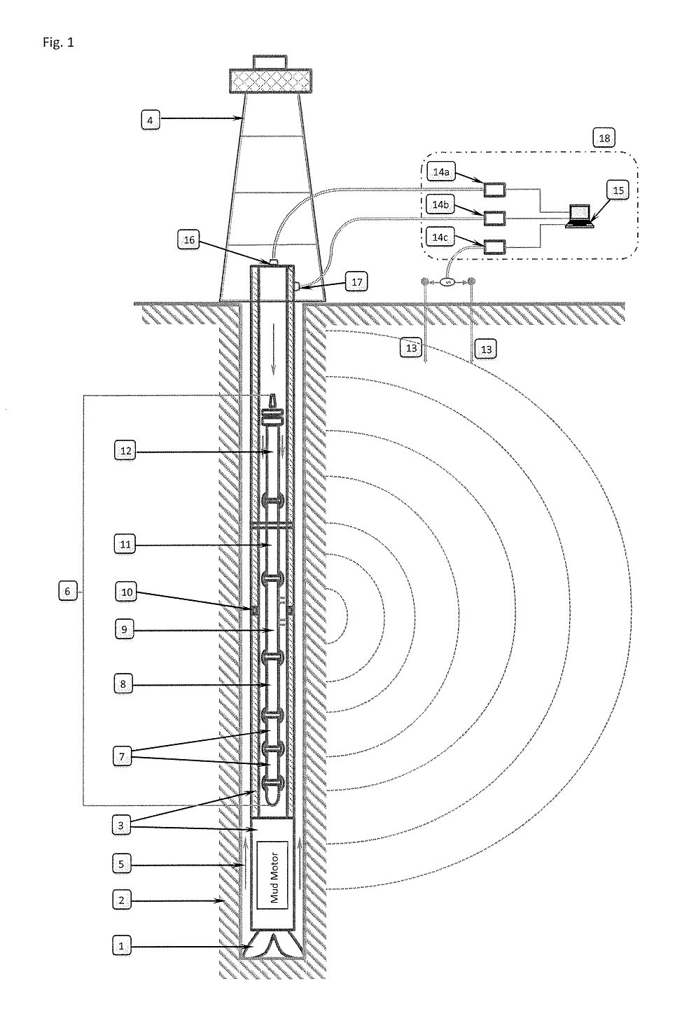

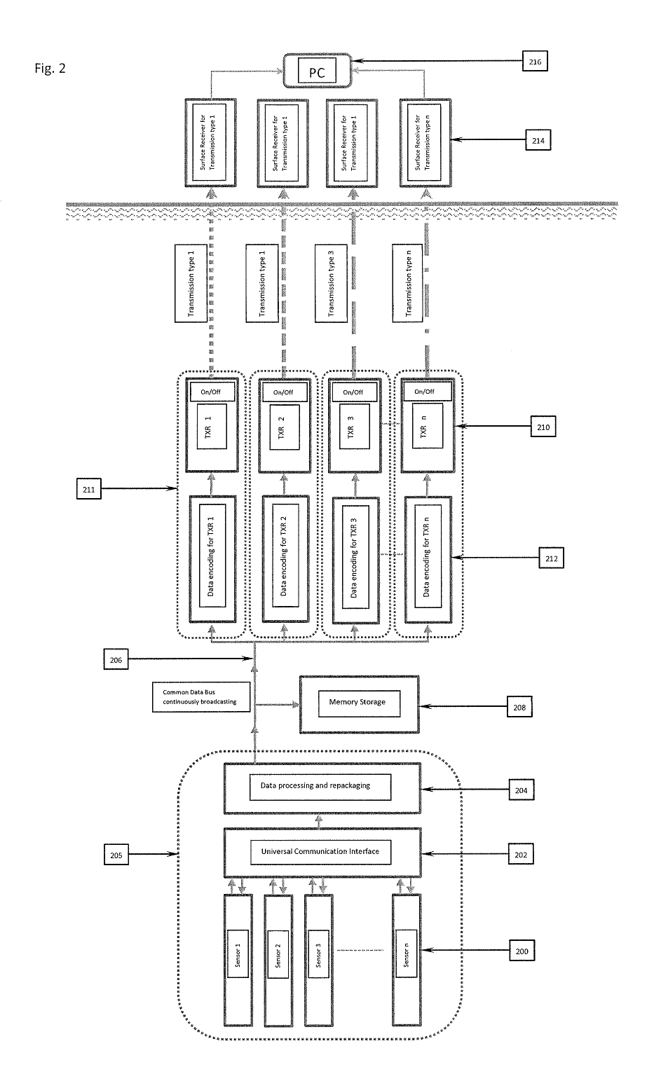

A method for multiple transmissions of data from a downhole sensor array will now be described with reference to FIG. 1 and FIG. 2.

### Structure and Relationship of Parts:

Referring to FIG. 1, in drilling of oil and gas wells a drill bit (1) is lowered into the earth (2) attached to a drill string (3) composed of multiple segments of drill pipe by a drilling rig (4). Drilling Fluid (5) is pumped through the drill string to power the drill bit and circulate cuttings out of the well bore. The position and progress of the drill bit is measured by a Measurement While Drilling (MWD) tool (6) that is located near the bottom of the drill string. The MWD tool is comprised of several components including multiple sensors (7) to measure parameters such as inclination, direction, rotation etc. as well as formation characteristics such as gamma ray and resistivity. Also in the MWD tool is a power supply (8) that may be comprised of batteries, generator, or alternator or combination thereof. Information from the sensors is processed, encoded and transmitted to surface via one or a combination of multiple transmitters including Mud Pulsers (12) or EM (9) or other methods such as acoustic (11).

Mud pulsers create either a pressure surge, pressure drop, or pressure wave that travels through the drilling fluid. On surface a pressure transducer (16) converts the pressure of the fluid to an electrical signal that is communicated to surface receivers (14A) which interacts with a computer to convert the signal to a data format utilized by the operator. Acoustic transmitters transmit an acoustic signal through the pipe and process the data on surface in a similar manner.

EM transmitters (9) function by applying a voltage across a non-conductive element of the drill string called a Gap Sub (10). The voltage potential is applied to the earth formation adjacent to the string and results in current flow being driven through the earth. Data from the EM transmitter is encoded in a variety of formats which are transmitted by either interrupting the current flow, or reversing the voltage in a timed sequence that is representative of the data transmitted. The current loops created by the transmitter are detected on surface by measuring the potential between ground rods (13) or between ground rods and the drill string. The readings from the ground rods are processed through surface receivers (14C) which interacts with a computer to convert the signal to a data format utilized by the operator.

The surface receivers for mud pulse, EM, acoustic or other methodology may be independent or housed within a common receiver unit. The surface receiver (s), computer(s), transducers, ground rods and ancillary equipment are referred to as a surface system (18). Each method of transmission has advantages and limitations in varied operating conditions. In order to change the type of transmitter utilized it is generally required to remove the

MWD tool from the well bore and replace it with another. This can be an expensive operation and result in other issues associated with interrupting the drilling operations. The ability to run multiple transmission methods at the same time reduces these costs and associated issues and if operated concurrently increased the frequency (data rate) of information transmitted to the surface system for use by the operator in drilling of the well bore.

### Operation:

Referring to FIG. 1, three different types of data transmitters have been illustrated EM transmitter (9), acoustic transmitter (11) and mud pulse transmitter (12). It will be appreciated that there are other different types of transmitters that may be used. There may also be new types of transmitters developed in future. EM transmitter (9), acoustic transmitter (11) and mud pulse transmitter (12) (and possibly further transmitters), transmit data to surface contemporaneously. This is facilitated by a continuous unidirectional data stream from the downhole sensor array (7) to EM transmitter (9), acoustic transmitter (11) and mud pulse transmitter (12). While contemporaneous transmission is the preferred manner of operating, it will be appreciated that the data transmitters may be selectively activated and deactivated. This enables a single data transmitter to be operating, selected data transmitters or all data transmitters.

Data from the sensor array (7) is sent to the transmitter assembly at regular intervals. As the data is sent automatically there is no requirement for the main processor in each transmitter assembly to “request data” from the sensor array. Once each transmitter has the data from the sensor array it encodes the data to the applicable transmission method (EM, Mud Pulse Acoustic, etc.) and then transmits it to surface. The use of an auto-send continuous uni-directional method between the sensor array and the transmitter assembly allows any number of transmitters to monitor and draw information from the common data bus line out of the sensor array at the same time. The processors in each transmitter assembly are always listening to the common data bus line from the sensor array. In order to run multiple transmitter assemblies one does not need to employ a switching device between each transmitter assembly and the sensor array. Each transmitter assembly processor may listen to the same output from the sensor at the same time.

Referring to FIG. 2, a schematic view is provided of the method. Sensor blocks 200 shows Sensor 1 through sensor n, communicating with Interface block 202 which shows a universal communications interface. There is unidirectional communication from the universal communications interface to a processor in Processor Block 204 which processes and repackages the data. All of the components cited above constitute the sensor array 205.

There is a unidirectional signal to a common data bus in data bus block 206 which continuously broadcasts data, with provision for memory storage in storage block 208. The transmitter assembly Block 211 is comprised of a transmitter Block 210 and associated data encoding Block 212. Transmitter Blocks 210, show transmitter 1 through transmitter n. The data for transmitter 1 through transmitter n is encoded for transmission in respective data encoding blocks 212 then sent to the transmitter for transmission to surface receivers shown with receiver blocks 214. The surface receivers in receiver blocks provide the transmitted data to a computer in computer block 216.

### Variations:

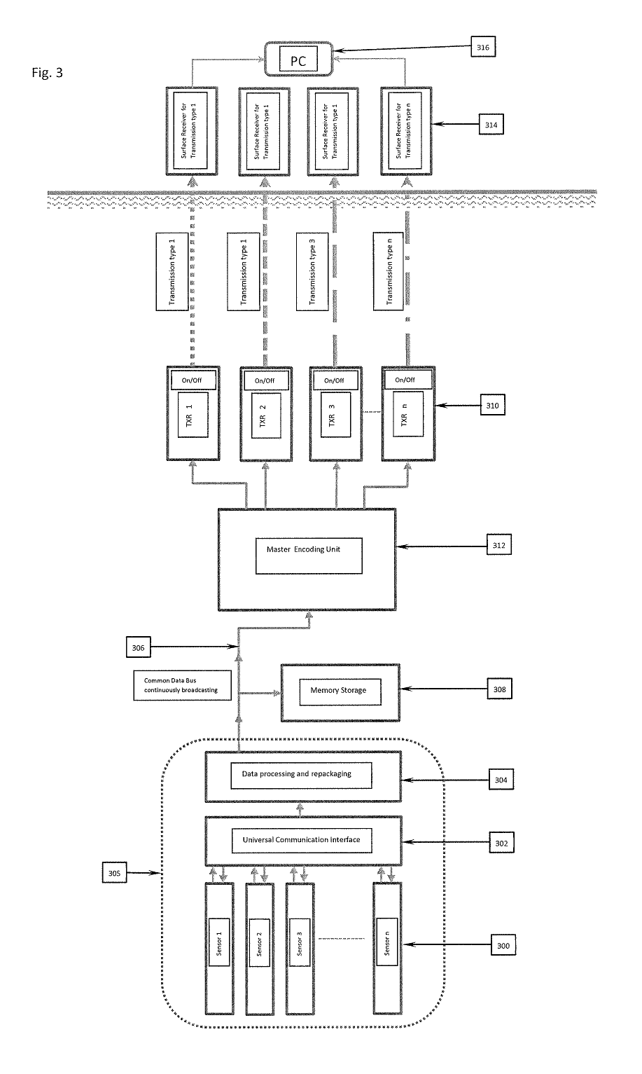

A variation of what has been described is shown in FIG. 3 and involves replacing the individual encoding processors Block 212 in each transmitter assembly Block 211 and positioning a single processor 312 reffered to as Master Encoding Unit that encodes data for all the different transmitters. With this variation, the Master Encoding Unit would obtain information from the sensor array, encode and construct a package of information to besent to the different transmitters in an “auto send mode”. Again in this configuration the transmitters do not request (poll) the data from the sensor array.

Referring to FIG. 3, a schematic view is provided of a variation on the method. The variation is very similar to FIG. 2. Sensor blocks 300 shows Sensor 1 through sensor n, communicating with Interface block 302 which shows a universal communications interface. There is unidirectional communication from the universal communications interface to a processor in Processor Block 304 which processes and repackages the data. All of the components cited above constitute the sensor array Block 305. There is a unidirectional signal to a common data bus in data bus block 306 which continuously broadcasts data, with provision for memory storage in storage block 308. Transmitter Blocks 310, show transmitter 1 through transmitter n. The data for transmitter 1 through transmitter n is encoded for transmission in a single data encoding device called the Master Encoding Unit block 312 and sent to each transmitter for transmission to surface receivers shown with receiver blocks 314. The surface receivers in receiver blocks provide the transmitted data to a computer in computer block 316. In this variation, all of the functionality of multiple data encoding blocks 212 resides in single encoding block 312. Single encoding block 312 denotes a processor also referred to as a Master Encoding Unit that is capable of contemporaneously encoding the data differently for each of the various transmitter types transmitter 1 through transmitter n.

### Advantages:

The solution proposed by the Petrovic et al patents is to position a switching device (multiplexer) between the sensor array and each individual transmitter assembly. The switching device ensures that the sensor array is only in contact with a single transmitter at one time. This method has the disadvantage of only being able to effectively transmit with one method at a time. In contrast, the use of an auto-send continuous unidirectional data stream to multiple transmitter assemblies allows the system to operate and transmit from all transmitters at the same time. Depending upon the tool configuration a system that employs a switching device between the transmitter(s) and sensor array may have the limitation of only being able to function on one transmission mode at a time (that being the one that is actively connected to the sensors through the multiplexer). As each transmitter may function independently there is no requirement for the units to transmit in the same data format or speed. For example rather than EM mimic mud pulse, it may be transmit in a phase shift encoding at a higher data rate frequency (i.e. 5 bits per second) while the mud pulse utilizes a pulse position modulation at a lower data rate (½ bps). As each transmitter can operate independently of the other the system can send one type of data (i.e. gamma ray) on the pulse transmission, and another (i.e. survey data) on the EM or Acoustic transmitters.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A method for transmission of data from a downhole sensor array, comprising:
sending a continuous unidirectional data stream from the downhole sensor array to two or more different types of data transmitters at the same time; and
selectively activating one or more of the two or more different types of data transmitters to transmit the data from the downhole sensor array.

2. The method of claim 1, wherein more than one of the two or more different types of data transmitters are activated and contemporaneously transmit the data from the downhole sensor array.

3. The method of claim 1, wherein the two or more different types of data transmitters are selected from electromagnetic (EM) telemetry, electric dipole telemetry, mud pulse telemetry, or acoustic telemetry.

4. The method of claim 1, where data is communicated from the downhole sensor array to the two or more different types of data transmitters without the aid or use of a switching device to interrupt or disable communication from the downhole sensor array to any individual transmitter of the two or more different types of data transmitters.

5. The method of claim 1, wherein the two or more different types of data transmitters are controlled by a single processor which receives data from the downhole sensor array and encodes the data in more than one format to suit each of the two or more different types of data transmitters.
